(19) United States
(12) Patent Application Publication
(10) Pub. No.: US 2007/0013989 A1
(43) Pub. Date: Jan. 18, 2007

(54) Laser scanning unit and image forming apparatus having the same

(75) Inventor: Kyung-min Lim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/438,073

(22) Filed: May 22, 2006

(30) Foreign Application Priority Data
Jul. 18, 2005 (KR) 10-2005-0064788

(51) Int. Cl. G02B 26/08

(52) U.S. Cl. 359/223; 359/196

(57) ABSTRACT

A laser scanning unit scans a light beam onto a photoconductor to form a latent image. The laser scanning unit includes a light source that generates and radiates a light. A polygon mirror deflects and scans the light emitted from the light source. A driving motor drives and rotates the polygon mirror. A circuit substrate has a first surface on which the polygon mirror and the driving motor are coaxially mounted. A housing, to which the circuit substrate is coupled, includes an opening through which the polygon mirror is introduced in the inner space. A second surface of the circuit substrate to the opposite side of the polygon mirror is entirely exposed to the outside to function as a heat radiation surface. Thus, the heat dissipation characteristic of heating dissipation components, including a driving motor, is improved and the inner sealing of the laser scanning unit is secured.

### CROSS-REFERENCE TO RELATED PATENT APPLICATION

This application claims the benefit under 35 U.S.C. § 119(a) of Korean Patent Application No. 10-2005-0064788, filed on Jul. 18, 2005, in the Korean Intellectual Property Office, the entire disclosure of which is hereby incorporated by reference.

### BACKGROUND OF THE INVENTION

1. Field of the Invention

The present invention relates to a laser scanning unit. More particularly, the present invention relates to a laser scanning unit in which the heat dissipation characteristic of the heat generating components, including a driving motor, is improved and an inner sealing characteristic thereof is secured.

2. Description of the Related Art

Generally, a laser scanning unit (LSU) is employed in laser printers, digital photocopiers, bar code readers, and facsimiles to form a latent image on a photoreceptor by main scanning via a beam deflector and sub-scanning via the rotation of the photoreceptor. FIG. 1 illustrates an LSU disclosed in Japanese Patent Publication No. 2001-142023. Referring to FIG. 1, a polygon mirror 21 is placed in an accommodating space provided by an optical chamber 10 and a cover 60. The polygon mirror 21 is placed between a cover member 31 surrounding the upper portion of the accommodating space and a flange 32 surrounding the lower portion of the same. A heat dissipation fin 25 is installed in a motor 23 driving the polygon mirror 21 to be exposed to the outside. A laser circuit substrate 11 is placed in the upper portion of the cover 60 to hermetically seal the optical chamber 10. However, due to the space for installing the heat dissipation fin 25 for dissipating heat of the motor 23, it is difficult to reduce the size of the LSU, and additional efforts and costs are required to manufacture an additional heat dissipation fin 25.

Accordingly, a need exists for a laser scanning unit having improved heat dissipation characteristics.

### SUMMARY OF THE INVENTION

The present invention provides a laser scanning unit (LSU) having a structure optimal for simplification and improved heat dissipation characteristic of heat generating components, including a driving motor.

The present invention also provides an LSU, the inside of which is secured to be sealed.

An LSU scans a light beam onto a photoconductor to form a latent image thereon. The laser scanning unit includes a light source generating and radiating a light, a polygon mirror deflecting and scanning the light emitted by the light source, a driving motor driving and rotating the polygon mirror, a circuit substrate having a first surface on which the polygon mirror and the driving motor are coaxially mounted, and a housing to which the circuit substrate is coupled and that includes an opening through which the polygon mirror is introduced in the inner space of the LSU. A second surface of the circuit substrate is opposite to the polygon mirror and is entirely exposed outside of the housing to function as a heat dissipation surface.

A step coupling unit may be formed along the opening and has a step into which the circuit substrate is inserted. The step coupling unit may be a rectangular lattice having an opening in the center.

The step coupling unit may include a base frame that surrounds the opening to a predetermined width and protrudes toward the inside of the opening. A sealing member protrudes toward the inner space along.the base frame. A circuit substrate assembled in the step coupling unit may be closely adhered to the base frame. A rim member may be formed to protrude along the outline of the circuit substrate. The sealing member of the step coupling unit and the rim member of the circuit substrate assembled in the step coupling unit may be disposed to face each other.

At least one coupling boss, which is coupled with a screw member passing through the circuit substrate, may be formed in the step coupling unit. A location determination pin may be inserted in a coupling hole formed in the circuit substrate to set an assembly location of the circuit substrate in the step coupling unit.

A driving motor and a driver IC (integrated circuit), which applies control signals to the driving motor, may be mounted on the circuit substrate. The driver IC may be mounted on a second surface of the circuit substrate that is exposed to the outside. A connector to which external cables are connected may be installed on the exposed surface of the circuit substrate.

The circuit substrate may be a metal printing circuit substrate mainly made of a conductive material.

A scanning optical lens may be disposed on the light path between the polygon mirror and the photoconductor to correct the light beam scanned by the polygon mirror with different magnifications along a scanning direction.

A collimating lens converting a divergent light from the light source into a parallel light, an aperture excluding a portion of the converted parallel light to shape in a predetermined form, and a cylindrical lens focusing the shaped light beam on the polygon mirror may be sequentially disposed between the light source and the polygon mirror.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is an elevational view of a laser scanning unit (LSU) disclosed in Japanese Patent Publication No. 2001-142023;

FIGS. 2 and 3 are perspective views of an LSU according to an exemplary embodiment of the present invention; and

FIG. 4 is another perspective view of the LSU of FIGS. 2 and 3.

FIG. 5 is cross sectional view of an image forming apparatus having the LSU shown in the FIG. 2.

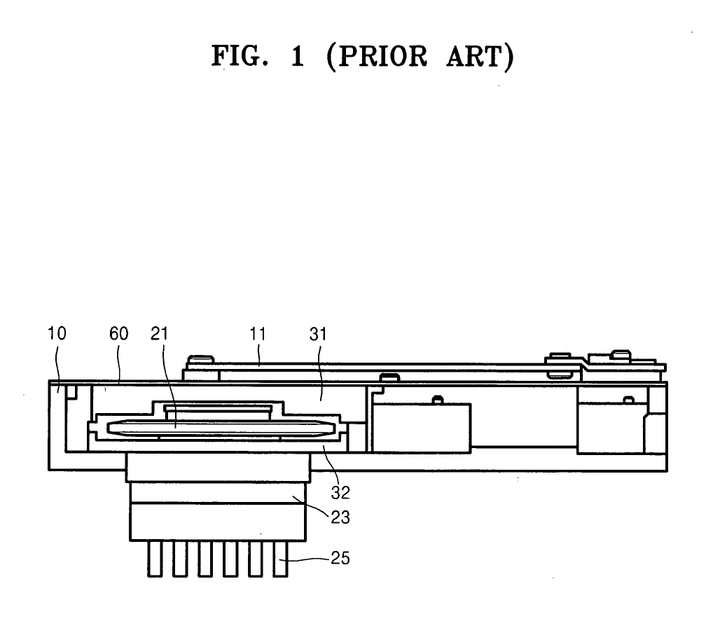

Throughout the drawings, like reference numerals will be understood to refer to like parts, components and structures.

### DETAILED DESCRIPTION OF EXEMPLARY EMBODIMENTS

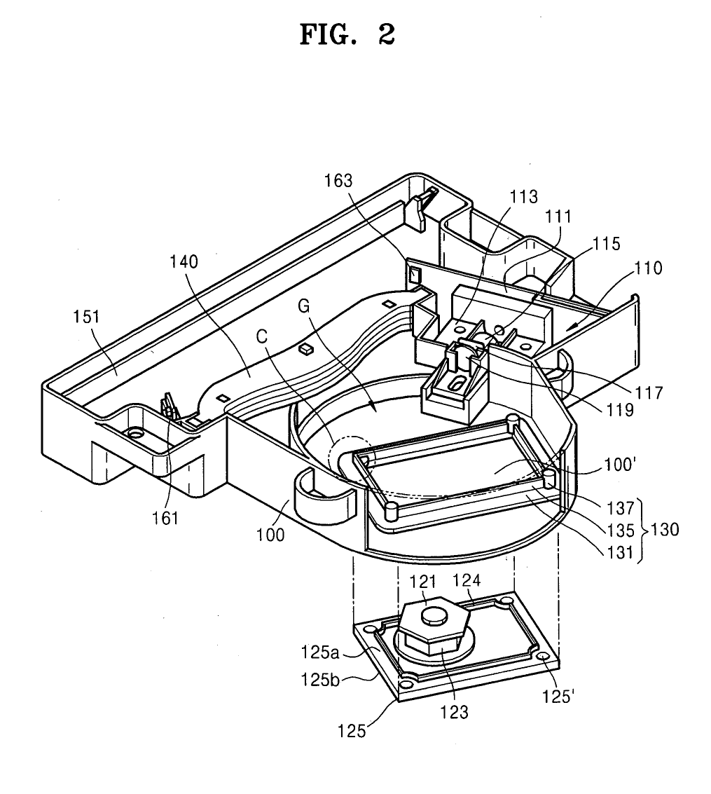

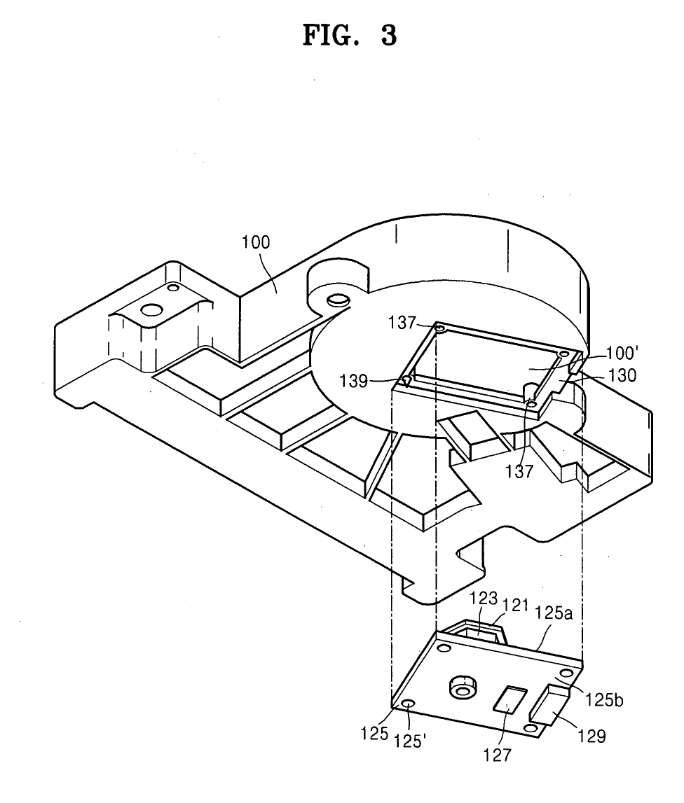

Hereinafter, the present invention is described in detail by explaining exemplary embodiments of the invention with reference to the attached drawings. FIGS. 2 and 3 are perspective views of a laser scanning unit (LSU) according to an exemplary embodiment of the present invention from different perspectives. The LSU includes a housing 100 and optical components placed in the housing 100. The housing 100 contains a scanning optical system, which scans a light beam onto a photoconductive drum (not shown) to form a latent image thereon, and supports its components directly or indirectly. The housing 100 has a shielding function to block foreign substances from entering the optical system from outside and a noise blocking function to block the driving noise of the optical system from being delivered to the outside. For this purpose, the upper end of the housing 100 is closed by a capping member (not shown), which is formed to correspond to the upper end of the housing 100. Thus, an inner space G of the LSU is maintained in a sealed condition. The housing 100 is preferably made of an injection molding product, such as a resin material, but it may also be made of a metal, such as aluminum, having high heat conductivity. An opening 100′ and a step coupling unit 130 that surrounds the opening 100′ are formed in a predetermined area of the housing 100, which will be described in more detail later.

A light source unit 110 is placed at a side of the housing 100 to provide a light beam shaped in a predetermined form. The light source unit 110 includes a holder guide 113 in which a lens holder 115 is installed and a light emitting circuit substrate 111 coupled at the back of the holder guide 113. In front of the holder guide 113, an aperture 117 and a cylindrical lens 119 are placed sequentially. A light emitting device (not shown) is mounted on the light emitting circuit substrate 111 to generate and radiate a light beam. As a light emitting device, a light emitting diode (LED) or a laser diode (LD) may be used. The light beam emitted from the light emitting device is incident on the side of the lens holder 115 installed in the holder guide 113. The lens holder 115 is formed approximately as a hollow cylinder, in which a collimating lens is fixed to convert divergent light emitted from the light emitting device into parallel light.

The parallel light converted by the collimating lens passes through the aperture 117 disposed in the light proceeding direction to be shaped into a beam having a width in a main scanning direction, and then passes through the cylindrical lens 119 to converge in a sub-scanning direction and is focused on the polygon mirror 121, which will be described later. The main scanning direction indicates the direction in which a light beam is scanned by the polygon mirror 121, that is, the scanning line on the photoconductive drum, and, the sub-scanning direction indicates the rotation direction of the photoconductive drum.

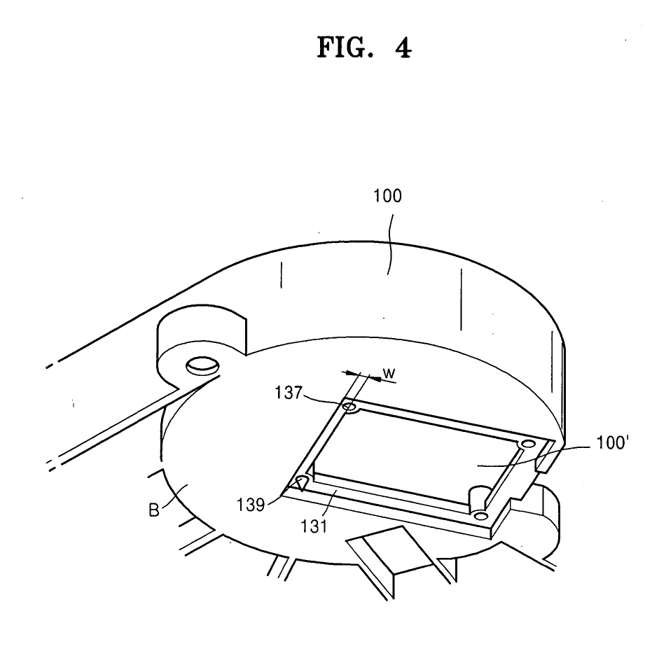

An approximately rectangular opening 100′ is formed in a predetermined area of the housing facing the light source unit 110. A step coupling unit 130 is formed to surround the opening 100′. A circuit substrate 125 is installed in the step coupling unit 130, and a driving motor 123 is mounted on the circuit substrate 125. A polygon mirror 121 is mounted on the rotation axis and rotates with high speed. The step coupling unit 130 includes a base frame 131 of a rectangular lattice form having an opening in the center and a sealing member 135 protruding to a predetermined height toward the inner space G along the base frame 131, as illustrated in the upper portion of FIG. 2. The base frame 131 is formed to surround the opening 100′ to a predetermined width. FIG. 4 is another perspective view of a step coupling unit 130. Referring to FIG. 4, the step coupling unit 130, more specifically the base frame 131, protrudes toward the inner side of the opening 100′ by a step width W. The base frame 131 forms a predetermined step with respect to the bottom B of the housing 100, and the assembled circuit substrate 125 is closely adhered on the step surface of the base frame 131 by a step width W. As the circuit substrate 125 is closely adhered to the stepped base frame 131, the sealing of the inner space G is improved. That is, the coupling area must be tightly sealed such that operating noise of the driving motor 123 is not released to the outside and foreign substances do not flow into the inside. Because the step coupling unit 130 forming steps builds a close coupling surface with the circuit substrate 125, the noise of the driving motor 123 inside is not delivered to the outside.

A sealing member 135 may be formed along the base frame 131, protruding from the base frame 131 to a predetermined height. The sealing member 135 is closely adhered to a rim member 124 formed on the circuit substrate 125 when the circuit substrate 125 is installed to help improve sealing of the inner space G. That is, the rim member 124 may be formed to protrude to a predetermined height along the outline of the circuit substrate 125, thus hermetically sealing the coupling area with the housing 100. Furthermore, when the rim member 124 faces the sealing member 135 of the step coupling unit 130 to be closely adhered thereto, sealing of the LSU may be further improved. The step coupling unit may be formed in various shapes as long as the step coupling unit forms a step with respect to the bottom B of the housing and provides a hermetically sealed coupling surface with the circuit substrate 125.

Coupling bosses 137 are formed at three comers of the base frame 131, as shown in FIGS. 2-4. The coupling bosses 137 are formed to protrude from the base frame 131 toward the inner space G. Further, coupling holes 125′ are formed at corners of the circuit substrate to correspond to the coupling bosses 137, and screw members (not shown) are coupled with the coupling bosses 137 that pass through the coupling holes 125. For this purpose, internal screws are formed to be coupled with the screw members inside the coupling bosses 137. Since the coupling bosses 137 protrude from the base frame 131 to a predetermined height, the light path from the polygon mirror 121 may be blocked by the coupling bosses 137. Thus, it is preferable that coupling bosses 137 not be formed in the light path or at corners near the light path. Instead, referring to FIG. 4, a location determination pin 139 may be formed protruding toward the outside or the circuit substrate 124 at a corner C (see FIG. 2). Furthermore, when the location determination pin 139 is inserted in the coupling holes 125′ of the circuit substrate 125, the coupling location of the circuit substrate 125 may be easily set, and the circuit substrate may be better assembled. The above described step coupling unit 130 may be molded as a single body with other parts of the housing 100, or may be combined to surround the opening of the housing 100 after being fabricated separately.

As illustrated in FIG. 2, the polygon mirror 121 is exposed toward the inner space G of the housing 100 through the opening 100′ formed on the bottom of the housing 100. More specifically, the polygon mirror 121 is introduced to face the light source unit 100 radiating a light beam. The polygon mirror 121 has an external lateral surface divided into a plurality of reflection surfaces. The light beam incident on the polygon mirror 121 is reflected by the reflection surfaces rotating with high speed and deflected in the main scanning direction. Then, the light beam is focused through a scanning optical lens 140, that is, an f-θ lens, in the main scanning direction with different magnifications, and imaged on the photoconductive drum (not shown) to form a latent image. A reflection mirror 151 converts the path of the light beam focused by the optical lens 140 to be guided onto the photoconductive drum. A window (not shown) made of a transparent glass is disposed at a side of the housing 100, and the light beam passes through the window and is scanned onto the conductive drums outside of the laser scanning unit. Also, a synchronization mirror 161 and an optical sensor 163, which receives a reflected light by the synchronization mirror 161, may be disposed between the scanning optical lens 140 and the reflection mirror 151 to synchronize the image data of the latent image and the scanning line.

As illustrated in FIG. 3, the circuit substrate 125 installed outside the housing 100 has a first surface 125a exposed toward the inner space G of the housing 100, and a second surface 125b on the opposite side entirely exposed toward the outside. As the circuit substrate 125 is coupled outside the housing 100, the second surface 125b is entirely exposed to the outside and thus substantially functions as a heat dissipation surface. A driving motor 123, a driver integrated circuit (IC) 127 supplying control signals and power, and a connector 129 receiving external power are mounted on the circuit substrate 125. Connection cables (not shown) are connected to the connector 129, and driving signals delivered from the outside by the connection cables pass through the driver IC 127 and are converted to be applied to the driving motor 123. In the present exemplary embodiment, the driving motor 123 driving the polygon mirror 121, the driver IC 127 controlling the driving motor 123, and the connector 129 receiving external power are mounted on the single circuit substrate 125, and especially, they may be placed on both sides 125a and 125b of the circuit substrate 125. That is, the driving motor 123 is installed on the first surface 125a of the circuit substrate 125, and the connector 129 and the driver IC 127 are mounted on the second surface 125b, the opposite side of the first surface 125a. The driver IC 127 is installed to be exposed to the outside to dissipate the heat generated by the driver IC 127 to the outside by natural convection. Also, because the connector 129, which is connected to the external circuit, is exposed to the outside of the housing 100, it is not necessary as in the prior art to sacrifice sealing of the LSU because of connection with the connector 129. In the prior art, in which a connector is installed inside a housing, pass holes are formed so that connection cables pass through the housing to be connected to the connector 129 inside of the housing. In the present exemplary embodiment, the connector 129 is exposed outside, thus pass holes for cables are not needed and a decrease in the sealing properties due to the pass holes is prevented. The circuit substrate 125, having a heat dissipation function itself, may be made of a metal of high heat conductivity with its external surfaces coated with an isolation material. The circuit substrate 125 contacts air from outside via the second surface 125b, which is entirely exposed outside of the housing 100, and the driving heat generated is released to the outside by natural convection.

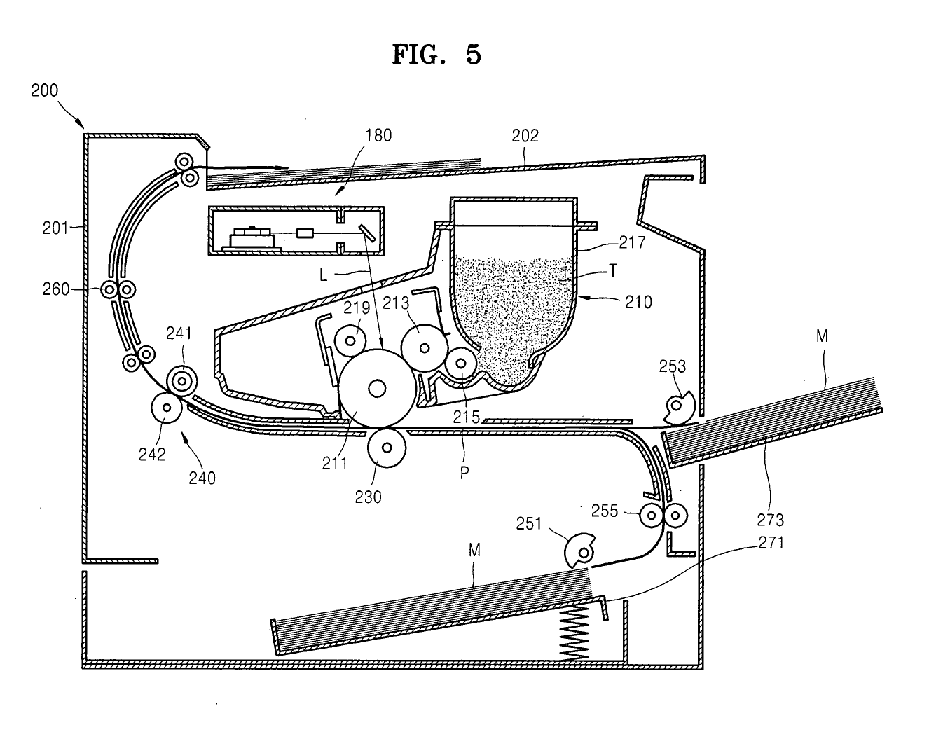

FIG. 5 illustrates an image forming apparatus 200 having the LSU shown in the FIG. 2. Referring to FIG. 5, the LSU 180 scans a light signal L into a developing unit 210 and onto a photoconductive drum 211 of the developing unit 210, and forms a latent image on the photoconductive drum 211, which is charged to a predetermined potential by a charge roller 219. The developing unit 210 includes the photoconductive drum 211 on a circumferential surface of which the latent image is formed by the LSU 180, a developing roller 213 supplying toner T to the photoconductive drum 211 and developing a toner image on the photoconductive drum 211 corresponding to the latent image, and a supply roller 215 proximal the developing roller 213 supplying the toner contained in the toner housing 217 to the developing roller 213.

The photoconductive drum 211, on which the toner image is formed, contacts a transfer roller 230 with a predetermined amount of pressure with a printing medium M therebetween. Thus, the toner image on the photoconductive drum 211 is transferred to the printing medium M, which passes between the photoconductive drum 211 and the transfer roller 230, and follows a transfer path P. The printing medium M is stored in a first feeding tray 271 or a second feeding tray 273, and then picked up piece by piece by a first pick-up roller 251 or a second pick-up roller 253, and supplied to the transfer roller 230. A paper aligner 255 is placed between the first pick-up roller 251 and the transfer roller 230. The paper aligner 255 feeds and aligns the printing medium so that the toner image may be transferred to a desired spot of the printing medium M.

A fuser 240 includes a heat roller 241 and a pressure roller 242 closely contacting each other and rotating in opposite directions to each other. As the printing medium M passes through between the heat roller 241 and the pressure roller 242, toner particles that are adhered to the printing medium M are thermally fused by a predetermined amount of heat and pressure. The printing medium M, on which a visible image is fused, passes between a pair of the feeding rollers 260 and is released outside of case 201 onto a face-down tray 202.

According to exemplary embodiments of the present invention, because a circuit substrate, on which a driving motor, a driver IC, and so forth, are mounted, is coupled outside of a housing, the surface of the circuit substrate is exposed to the outside of the housing and thus the heat dissipation characteristic is improved. Particularly, as a step coupling unit is formed in the coupling portion of the housing in which the circuit substrate is assembled, the laser scanning unit is sealed better and thus the noise generated during operation of the driving motor is substantially prevented and the quality of the product is improved. Moreover, a high speed and silent laser scanning unit may be provided because the noise of the driving motor is blocked.

Also, as the circuit substrate dissipates heat, no other heat dissipation devices, such as a cooling fan or a heat radiation fin, are required. Accordingly, the laser scanning unit may be manufactured at reduced costs and may have a simplified structure.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A laser scanning unit (LSU) that scans a light beam onto a photoconductor to form a latent image thereon, comprising:
a light source that generates and radiates light;
a polygon mirror that deflects and scans the light emitted by the light source;
a driving motor that drives and rotates the polygon mirror;
a circuit substrate having a first surface on which the polygon mirror and the driving motor are coaxially mounted; and
a housing to which the circuit substrate is coupled and that includes an opening through which the polygon mirror is introduced in the inner space of the LSU, a second surface of the circuit substrate opposite to the polygon mirror is entirely exposed to the outside of the housing to function as a heat dissipation surface.

2. The laser scanning unit of claim 1, wherein
a step coupling unit is formed along the opening and has a step into which the circuit substrate is inserted.

3. The laser scanning unit of claim 2, wherein
the step coupling unit is a rectangular lattice having an opening in the center.

4. The laser scanning unit of claim 2, wherein
the step coupling unit includes a base frame that surrounds the opening to a predetermined width and protrudes toward the inside of the opening and a sealing member protruding toward the inner space along the base frame.

5. The laser scanning unit of claim 4, wherein
a circuit substrate assembled in the step coupling unit is closely adhered to the base frame.

6. The laser scanning unit of claim 4, wherein
a rim member is formed to protrude along the outline of the circuit substrate.

7. The laser scanning unit of claim 6, wherein
the sealing member of the step coupling unit and the rim member of the circuit substrate assembled in the step coupling unit are disposed to face each other.

8. The laser scanning unit of claim 2, wherein
at least one coupling boss, which is coupled with a screw member passing through the circuit substrate, is formed in the step coupling unit.

9. The laser scanning unit of claim 2, wherein
a location determination pin is inserted in a coupling hole formed in the circuit substrate to set an assembly location of the circuit substrate in the step coupling unit.

10. The laser scanning unit of claim 1, wherein
a driving motor and a driver integrated circuit (IC), which applies control signals to the driving motor, are mounted on the circuit substrate.

11. The laser scanning unit of claim 10, wherein
the driver IC is mounted on a second surface of the circuit substrate that is exposed to the outside of the housing.

12. The laser scanning unit of claim 1, wherein
a connector to which external cables are connected is installed on the exposed surface of the circuit substrate.

13. The laser scanning unit of claim 1, wherein
the circuit substrate is a metal printing circuit substrate substantially made of a conductive material.

14. The laser scanning unit of claim 1, wherein a scanning optical lens is disposed in the light path between the polygon mirror and the photoconductor to correct the light beam scanned by the polygon mirror with different magnifications along a scanning direction.

15. The laser scanning unit of claim 1, wherein a collimating lens converting a divergent light from the light source into a parallel light, an aperture excluding a portion of the converted parallel light to shape the light in a predetermined form, and a cylindrical lens focusing the shaped light beam on the polygon mirror are sequentially disposed between the light source and the polygon mirror.

16. An image forming apparatus, comprising:
a laser scanning unit to scan a light signal onto a photoconductive drum to form a latent image; and
a developing unit to develop the latent image formed on the photoconductive drum as a visible image on a printing medium, the laser scanning unit including a light source that generates and radiates light;
a polygon mirror that deflects and scans the light emitted by the light source;
a driving motor that drives and rotates the polygon mirror;
a circuit substrate having a first surface on which the polygon mirror and the driving motor are coaxially mounted; and
a housing to which the circuit substrate is coupled and that includes an opening through which the polygon mirror is introduced in the inner space of the LSU, a second surface of the circuit substrate opposite to the polygon mirror is entirely exposed to the outside of the housing to function as a heat dissipation surface.

17. The image forming apparatus of claim 16, wherein a step coupling unit is formed along the opening and has a step into which the circuit substrate is inserted.

18. The image forming apparatus of claim 17, wherein the step coupling unit is a rectangular lattice having an opening in the center.

19. The image forming apparatus of claim 1ing unit of claim 17, wherein the step coupling unit includes a base frame that surrounds the opening to a predetermined width and protrudes toward the inside of the opening and a sealing member protruding toward the inner space along the base frame.

20. The image forming apparatus of claim 19, wherein a circuit substrate assembled in the step coupling unit is closely adhered to the base frame.

21. The image forming apparatus of claim 19, wherein a rim member is formed to protrude along the outline of the circuit substrate.

22. The image forming apparatus of claim 21, wherein the sealing member of the step coupling unit and the rim member of the circuit substrate assembled in the step coupling unit are disposed to face each other.

23. The image forming apparatus of claim 17, wherein at least one coupling boss, which is coupled with a screw member passing through the circuit substrate, is formed in the step coupling unit.

24. The image forming apparatus of claim 17, wherein a location determination pin is inserted in a coupling hole formed in the circuit substrate to set an assembly location of the circuit substrate in the step coupling unit.
